(19) United States
(12) Patent Application Publication
(10) Pub. No.: US 2017/0106531 A1
(43) Pub. Date: Apr. 20, 2017

(54) ROBOTIC INSPECTION DEVICE

(71) Applicants: PETRÓLEO BRASILEIRO S.A. - PETROBRAS, Rio de Janeiro (BR); STATOIL BRASIL ÓLEO E GAS LTDA, Rio de Janeiro (BR); UNIVERSIDADE FEDERAL DO RIO DE JANEIRO - UFRJ, Rio de Janeiro (BR)

(72) Inventors: Romankevicius COSTA, Rio de Janeiro (BR); Gustavo Medeiros DE FREITAS, Minas Gerais (BR); Pal Johan FROM, Rio de Janeiro (BR); Guilherme Pires De Sales DE CARVALHO, Rio de Janeiro (BR); Mauricio GALASSI, Rio de Janeiro (BR); Andres ROYROY, Bergen (NO); Peter Wilhelmus Jacques DERKS, Rio de Janeiro (BR)

(73) Assignees: PETRÓLEO BRASILEIRO S.A. - PETROBRAS, Rio de Janeiro (BR); STATOIL BRASIL ÓLEO E GAS LTDA, Rio de Janeiro (BR); UNIVERSIDADE FEDERAL DO RIO DE JANEIRO - UFRJ, Rio de Janeiro (BR)

(21) Appl. No.: 15/292,910

(22) Filed: Oct. 13, 2016

(30) Foreign Application Priority Data
Oct. 14, 2015 (BR) 10 2015 026049-0

(51) Int. Cl. B25J 9/08; B25J 5/02

(52) U.S. Cl. CPC B25J 9/08; B25J 5/02; F16H 1/28

(57) ABSTRACT

The present invention relates to a robotic inspection device (10) comprising at least one pair of robotic modules (1) connected together by means of an articulated joint (9), with at least one displacement device (2) coupled to a rail (11); the displacement device (2) comprising at least one pair of pivoted brackets (3); at least one of the robotic modules (1) comprising at least one within an instrumentation system (7) and a manipulator arm (8).

### INVENTION FIELD

The present invention relates to a robotic inspection device.

More specifically, the present invention relates to a robotic inspection device used to inspect, monitor and perform maintenance in confined or difficult-to-access areas.

### BASIS OF THE INVENTION

Oil platforms periodically require inspections and maintenance, which are mainly performed by operators on board.

However, some sites that are to be inspected or at which maintenance is to be performed are difficult to access and/or are hazardous to the operator, since such sites pose risks of explosions and fire, and toxic gases are present.

Additionally, most of the equipment to be inspected is far from the ground, which requires the installation of scaffolding, thereby increasing maintenance time and the risk of accidents.

One solution found in the prior art for such a drawback is described in Korean document KR486029, which describes a method for controlling a mobile robot used to perform accurate repairs in a confined space. The robot is controlled by means of modulated signals, which are transmitted by superimposing the modulated signals onto the power supply of the robot. When a signal is sent, the robot separates it from the power supply, decodes it and displays it on a display or performs the command sent.

However, this solution has the drawback that it cannot be used in places where the equipment to be monitored and serviced is a certain distance from the ground, since the device is used in areas where the device can move on level or slightly sloped ground.

Another solution found in the prior art is described in Brazilian document P10406006-7, which describes a robotic device used in enclosed surrounding environments and that moves within the inner portion of the environment. The device comprises a data acquisition system for monitoring the activity to be developed and a system for transmitting data in order to remotely send commands to the device. This device has sealing, location and operation control systems as accessories. The document also describes that this device was developed for internal repair of pipelines.

However, this solution has the drawback that it can only be used in the inner portion of pipelines, preventing monitoring and inspection of other types of external equipment.

Therefore, the state of the art does not include a robotic inspection device to reduce the time of inspection and/or maintenance of an object, to facilitate the inspection and/or maintenance of an object located in a place that is difficult to access or in a confined space and that reduces the risk to health and, consequently, increases operator safety.

### OBJECTIVES OF THE INVENTION

Therefore, an objective of the present invention is to provide a robotic inspection device that reduces the time of inspection and/or maintenance of an object.

Another objective of the present invention is to provide a robotic inspection device that facilitates the inspection and/or maintenance of an object located in a place that is difficult to access or in a confined space.

Another objective of the present invention is to provide a robotic inspection device that reduces the risk to health, increasing operator safety.

### SUMMARY

The present invention meets these and other objectives by means of a robotic inspection device that has the advantage of increasing productivity and efficiency of the inspection process and maintenance of equipment; it reduces downtime of equipment in confined spaces or that is difficult to access and reduces risks to the operator's health.

The robotic inspection device comprises at least one pair of robotic modules connected together by means of an articulated joint and with at least one displacement device coupled to a rail; the displacement device comprises at least one pivoting displacement device and at least one of the robotic modules comprising at least one that is within an instrumentation system and a manipulator arm.

### BRIEF DESCRIPTION OF THE DRAWINGS

The present invention will be described below in more detail, with reference to the appended drawings, in which:

FIG. 1 is a perspective view of the robotic inspection device according to the preferred embodiment of the present invention, the device being shown schematically installed on an operating space.

FIG. 2 is a detailed view of the robotic inspection device according to the preferred embodiment of the present invention, the device being shown installed on the drive rail.

FIG. 3 is a perspective view of the robotic module according to the preferred embodiment of the present invention.

FIG. 4 is a perspective view of the pivotable bracket according to the preferred embodiment of the present invention.

FIG. 5 is a perspective view of the pivotable bracket according to the preferred embodiment of the present invention.

FIG. 6 is a perspective view of the rail according to the preferred embodiment of the present invention.

### DETAILED DESCRIPTION OF THE INVENTION

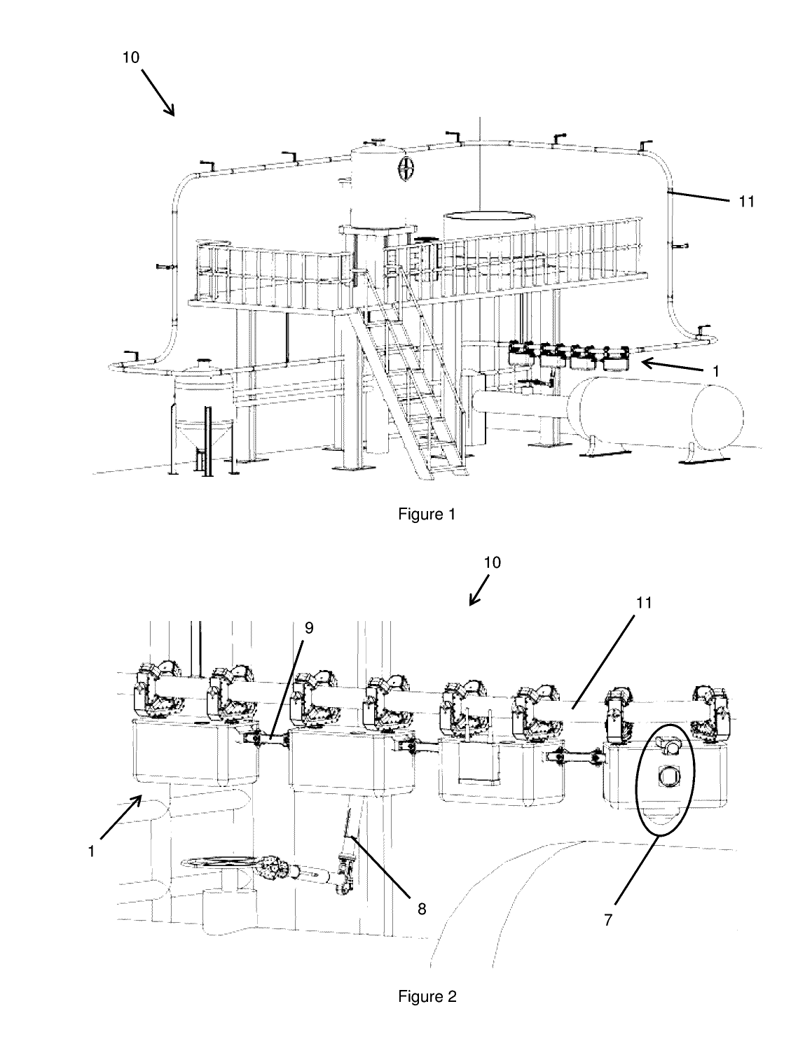

FIG. 1 illustrates a preferred embodiment of robotic inspection device 10 of the present invention.

For a better understanding of the invention, the detailed description of the robotic inspection device is provided, with the device being used on an oil platform. However, it should be noted that the robotic inspection device can be used anywhere that requires inspection of equipment located in confined or difficult-to-access places.

As can be seen in FIGS. 1 and 2, the robotic inspection device 10 comprises a rail 11 and at least two robotic modules 1 coupled together by means of an articulated joint 9.

The rail 11 comprises a series of straight and curved tubular elements, which are connected to each other, forming a path through which the robotic modules 1 move, as can best be seen in FIGS. 1 and 6.

It should be noted that the rails 11 should be installed in areas of interest, in which the equipment to be inspected is located. Thus, preferably, the rails 11 are installed on a path close to the areas and equipment that require constant maintenance.

The articulated joints 9 are used to prevent the robotic modules 1 from rotating around the rail 11 and are provided with a series of discs attached to steel cables with springs at their ends.

The steel cables and springs provide flexibility when the robotic module 1 makes curved movements and the discs provide rigidity to the assembly, limiting deformation of the articulated joint 9.

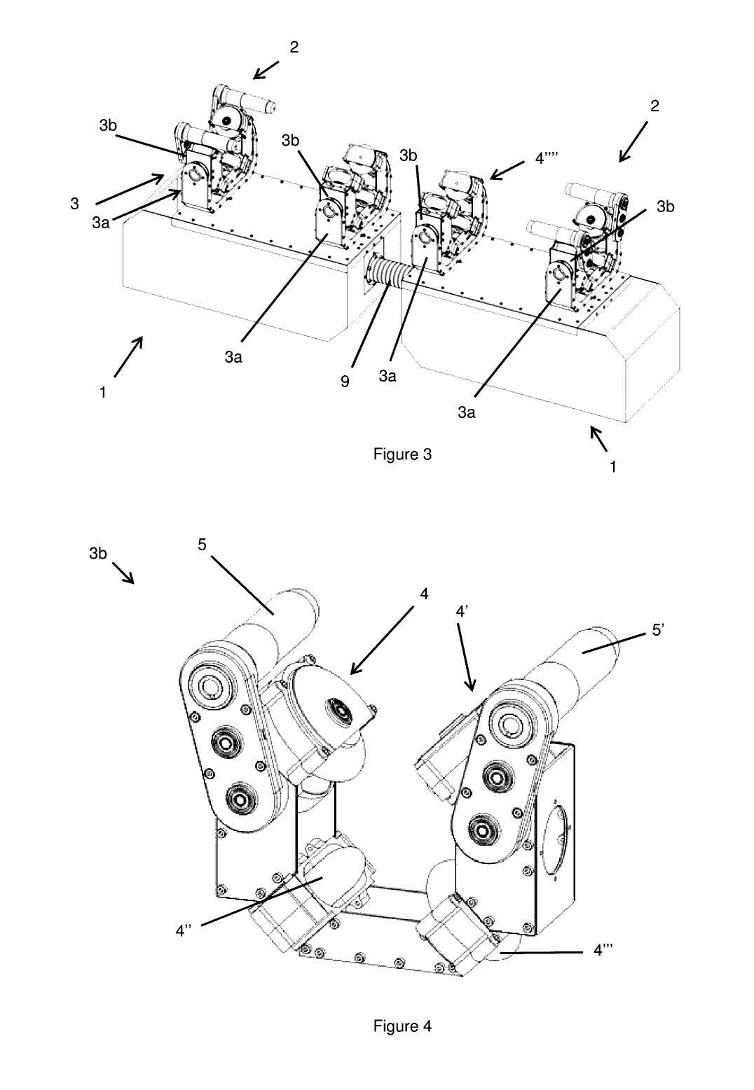

As can be seen in FIGS. 3, 4 and 5, the robotic modules 1 are connected together by means of an articulated joint 9 and have at least one means for displacement 2.

The displacement means 2 comprises at least one pivoting device 3, the objective of which is to move the robotic module 1. In the preferred embodiment of the invention shown in FIG. 1, the means of displacement 2 of each robotic module 1 comprises two pivoting displacement devices 3.

Preferably, the pivoting displacement device 3 comprises a first pivotable bracket 3a coupled to the upper portion of the robotic module 1 and a second pivotable bracket 3b coupled to the first pivotable bracket 3a.

The coupling between the first and second pivotable brackets 3a, 3b is orthogonal to the coupling of the first pivotable bracket 3a at the upper portion of the robotic inspection device 10; in this way, the robotic module 1 can move over the vertical and horizontal axis.

FIG. 4 is an enlarged view of a preferred embodiment of the second pivotable bracket 3b. As can be seen in this figure, the second pivotable bracket 3b comprises at least two wheels 4, 4′ positioned diametrically opposed in its upper portion.

Preferably, the second pivotable bracket 3b comprises four wheels 4, 4′, 4″, 4′″, and two wheels 4, 4′ are located diametrically opposed in its upper portion, and the other two wheels 4″, 4′″ are located diametrically opposed in the bottom portion, as shown in FIG. 4.

This preferred embodiment of the second pivotable bracket 3b has the advantage of preventing rotation of the robotic module 1, since there is friction in the wheels 4, 4′, 4″, 4′″ with the external portion of the rail 11, plus the fact that the wheels 4, 4′, 4″, 4′″ are tightly coupled to the surface of the rail 11, which prevents gaps between these elements.

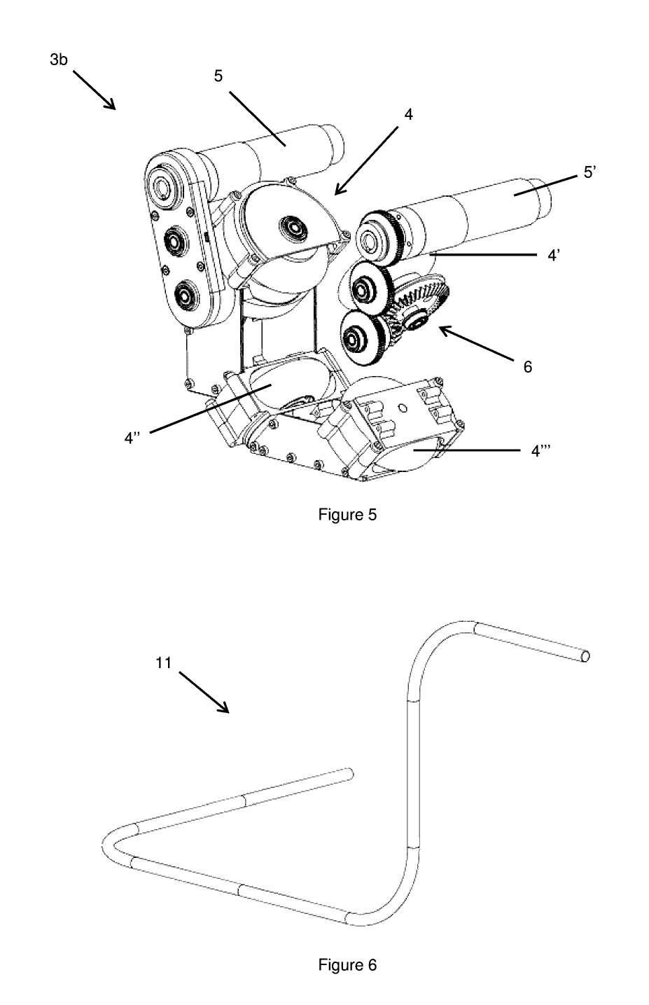

As can best be seen in FIGS. 3 and 5, in the preferred embodiment of the present invention, at least one of the pivoting displacement devices 3 comprises a motor for driving the module 1. Thus, the motorized device 3, the upper wheels 4, 4′ of the pivotable bracket 3b are each coupled to an electric motor 5, 5′ by means of a gear system 6 (see FIG. 5).

Thus, in this preferred embodiment, the displacement means 2 of each robotic module 1 comprises a pivoting displacement device 3 whereby the second pivotable bracket is connected to the motor 5 and a displacement device 3 without a motor 5 (see FIG. 3).

The gear system 6 comprises a planetary gear coupled to the electric motor 5, 5′, a first spur gear coupled to a planetary gear and connected to a second spur gear, a third spur gear connected to a second spur gear and coupled to a first bevel gear and a second bevel gear connected to the first bevel gear and coupled to the wheel 4, 4′.

The electric motors 5, 5′ are triggered by drivers with dedicated power. The drivers with power have the objective of controlling the position, speed and torque of each motor individually.

The first and second pivotable brackets 31a, 31b are preferably gimballs. However, other types of brackets can be used, provided that the objectives are met.

In the preferred embodiment, each robotic module 1 comprises a system or feature for performing inspections and/or maintenance.

Thus, as best shown in FIG. 2, a robotic module 1 may comprise an instrumentation system 7 and another robotic module 1 may comprise a mechanical arm 8.

The objective of the mechanical arm 8 is for it to be used to inspect and collect samples of inspected objects.

Meanwhile, the instrumentation system 7 is used to acquire data from the environment to be inspected by means of sensors. The number and type of sensors to be used vary according to the type of equipment and/or location to be inspected.

The sensors may, for example, be a fixed, pan-tilt-zoom (PTZ), thermal, panoramic or stereoscopic camera, a probe to detect hydrocarbons and combustible gases, a sensor for acoustic noise or a vibration sensor.

The data collected by the sensors are analyzed by a signal-processing algorithm system, capable of detecting irregularities along the inspected environment.

The irregularities that can be detected are, for example, intrusion, abandoned objects, smoke, fire, gas or liquid leakage and malfunction of machinery.

Furthermore, the electric motors 5, 5′, the instrumentation system 7 and the mechanical arm 8 are manipulated by a control system.

The robotic inspection device 10 requires power supply so that all of its components can be used. To this end, the device 10 uses a power system.

Such a system may use batteries that are allocated within the robotic module 1 or by conventional means, which consists of a remote power source connected by cables.

Additionally, the robotic inspection device 10 has a communications system comprising wireless equipment and cables, the objective of which is to exchange data between the modules 1 and between the modules 1 and a command base.

Thus, one attains a robotic inspection device that reduces the time of inspection and maintenance of an inspected object.

One also attains a robotic inspection device that facilitates inspection and maintenance of an object located in a place that is difficult to access or in a confined space, and reduces the risk to the operator's health, as the operator does not need to go into a harsh environment.

Having described an example of a preferred embodiment of the present invention, it should be understood that the scope of the present invention encompasses other possible variations of the invention described, being limited solely by the wording of the appended claims, including therein possible equivalents.

1. A robotic inspection device (10), characterized in that it comprises:
at least one pair of robotic modules (1) connected together by means of an articulated joint (9);
the robotic module (1) with at least one displacement device (2) coupled to a rail (11);
the displacement device (2) comprising a pivoting displacement device (3);
at least one of the robotic modules (1) comprising at least one within an instrumentation system (7) and a manipulator arm (8).

2. Robotic inspection device (10) according to claim 1, characterized in that the displacement device (2) comprises two pivoting displacement devices (3).

3. Robotic inspection device (10) according to claim 2, characterized in that each pivoting displacement device (3) comprises a first pivotable bracket (3a) coupled to the upper portion of the robotic module (1) and a second pivotable bracket (3b) coupled to the first pivotable bracket (3a), the coupling being orthogonal to the coupling of the first pivotable bracket (31) at the upper portion of the robotic inspection device (10).

4. Robotic inspection device (10) according to claim 3, characterized in that the second pivotable bracket (3b) of at least one of the pivoting displacement devices (3) has at least two wheels (4, 4′) positioned diametrically opposed; the wheel (4, 4′) being coupled to an electric motor (5, 5′); the wheels (4, 4′) being supported on the rail (11) and configured to move the robotic module (1, 1′).

5. Robotic inspection device (10) according to claim 4, characterized in that the coupling between the wheels (4, 4′) and the electric motor (5, 5′) is carried out by means of a gear system (6).

6. Robotic inspection device (10) according to claim 5, characterized in that the gear system (6) comprises a planetary gear coupled to the electric motor (5, 5′), a first spur gear coupled to a planetary gear and connected to a second spur gear, a third spur gear connected to a second spur gear and coupled to a first bevel gear and a second bevel gear connected to the first bevel gear and coupled to the wheel (4, 4′).

7. Robotic inspection device (10) according to claim 1, characterized in that one of the robotic modules (1) has an instrumentation system (7) and other robotic modules (1) have a manipulator arm (8).
